(19) United States
(12) Patent Application Publication
(10) Pub. No.: US 2025/0383152 A1
(43) Pub. Date: Dec. 18, 2025

(54) METHOD FOR OPERATING ELECTRIC FURNACE

(71) Applicant: Hyundai Steel Company, Incheon (KR)

(72) Inventors: Dae Hoon Shin, Incheon (KR); Jong Oh Jo, Incheon (KR); Sang Hyeok Lee, Incheon (KR); Myoung Cheol Shin, Incheon (KR)

(21) Appl. No.: 19/285,962

(22) Filed: Jul. 30, 2025

Related U.S. Application Data
(63) Continuation of application No. PCT/KR2024/095127, filed on Feb. 14, 2024.

(30) Foreign Application Priority Data
Mar. 2, 2023 (KR) 10-2023-0027733

(51) Int. Cl. F27B 3/22; F27B 3/04; F27B 3/08

(52) U.S. Cl. CPC F27B 3/22; F27B 3/045; F27B 3/08

(57) ABSTRACT

A method of operating an electric furnace is provided. A method of operating an electric furnace includes melting a first iron source in a first melting furnace in which a first electrode unit is disposed, preheating a second iron source in a second melting furnace in which a second electrode unit is disposed, and melting the second iron source in the second melting furnace, wherein the first melting furnace and the second melting furnace share an internal space, in the preheating of the second iron source, the second electrode unit emits a first gas, and in the melting of the second iron source, the second electrode unit emits a second gas that is different from the first gas.

### CROSS-REFERENCE TO RELATED APPLICATIONS

This application is a continuation of International Application No. PCT/KR2024/095127 filed on Feb. 14, 2024, which claims under 35 U.S.C. § 119 (a) the benefit of Korean Patent Application No. 10-2023-0027733 filed on Mar. 2, 2023, the entire contents of which applications are incorporated by reference herein.

### TECHNICAL FIELD

The present invention relates to a method of operating an electric furnace.

### BACKGROUND ART

In general, steel material production processes in the steel industry may be mainly classified into blast furnace-converter production systems (converter processes) that use an ore as a main raw material and electric furnace production systems (electric furnace processes) that use scrap, which is collected/recycled after a produced steel material is used to make a product, as a main raw material.

Converter processes are widely used to produce high-quality products based on an ore and are mainly used to produce sheet metals that are sensitive with respect to surface defects or the like. In general, electric furnace processes are mainly applied to the production of bar steel and shape steel that require high strength because scrap may include impurities (Cu, Sn, Cr, Mo, Ni, and the like) (hereinafter collectively referred to as tramp elements).

Recently, as carbon neutrality has become a global issue, electric furnace processes, in which CO₂ emission is 20% or less of CO₂ emission of converter processes, is emerging as an alternative for future steel production.

Due to tramp elements introduced from scrap, surface defects that occur during a continuous casting process may tend to worsen during a rolling process, and electric furnace processes may have low processability characteristics.

To overcome such limitations, active use of ore-based iron sources based on an iron ore (ore-based metallics (OBMs), for example, direct reduced iron (DRI), hot briquetted iron (HBI), pig iron (PI), granulated pig iron (GPI), and the like) is being considered as an alternative.

Representatively, there is DRI/HBI in which, unlike a blast furnace, iron ores are processed into pellets and allowed to react with a reducing gas to be directly reduced, thereby producing iron sources. Currently, the number of electric furnace steelmakers that apply iron ores to commercial facilities to produce sheet metals is increasing.

When ore-based iron sources are input into an electric furnace, due to a reduction structure in which a reducing gas penetrates into a solid raw material and reacts, a large amount of unreduced iron oxide (FeO) may be contained. Accordingly, an amount of slag that is produced may increase, and a molten steel collection rate may decrease.

In addition, due to the characteristics of a process of melting scrap using an arc (electrical energy), nitrogen (N₂) gas in the air around an electrode may be ionized (plasma) and injected into molten steel through an arc stream, which makes it difficult to control a nitrogen (N₂) content.

### DISCLOSURE

### Technical Problem

The problem to be solved by the present invention is to provide a method of operating an electric furnace, which is capable of effectively reducing iron oxide (FeO) included in slag and improving a molten steel collection rate even when direct reduced iron is used in an electric furnace.

Another problem to be solved by the present invention is to provide a method of operating an electric furnace, which is capable of more smoothly controlling a nitrogen (N₂) content in molten steel in an electric furnace.

The objects of the present invention are not limited to those described above, and other technical objects not described may become apparent to those of ordinary skill in the art based on the following descriptions.

### Technical Solution

According to one embodiment of the present invention for solving the above problem, a method of operating an electric furnace includes melting a first iron source in a first melting furnace in which a first electrode unit is disposed, preheating a second iron source in a second melting furnace in which a second electrode unit is disposed, and melting the second iron source in the second melting furnace, wherein the first melting furnace and the second melting furnace share an internal space, in the preheating of the second iron source, the second electrode unit emits a first gas, and in the melting of the second iron source, the second electrode unit emits a second gas that is different from the first gas.

The first gas may include a reducing gas, and the second gas may include an inert gas.

The reducing gas may include at least one selected from carbon dioxide (CO₂) gas, methane (CH₄) gas, and hydrogen (H₂) gas, and the inert gas may include argon (Ar) gas.

The first gas may further include an inert gas.

The melting of the second iron source may include initial melting and subsequent melting, in the initial melting, the second electrode unit may emit the second gas, and in the subsequent melting, the second electrode unit may emit a third gas that is different from the second gas.

The second gas may include an inert gas, and the third gas may include a reducing gas.

In the initial melting, the second electrode unit may be exposed to the outside, and in the subsequent melting, the second electrode unit may be at least partially submerged inside slag.

The melting of the first iron source may be performed simultaneously with the preheating of the second iron source and the melting of the second iron source.

In the melting of the first iron source, the first electrode unit may emit the third gas. The third gas may include a reducing gas.

The method may further include mixing the first slag inside the first melting furnace and the second slag inside the second melting furnace and refining a molten metal, wherein, in the refining of the molten metal, the first electrode unit may emit the third gas, and the second electrode unit may emit a fourth gas, wherein the third gas and the fourth gas may include a reducing gas.

The first electrode unit may include a first alternating current (AC) electrode rod, a second AC electrode rod, and a third AC electrode rod, and the second electrode unit may include an upper DC electrode and a lower DC electrode.

The upper direct current (DC) electrode may include an inner pipe which is defined to penetrate the upper DC electrode in a longitudinal direction and in which at least one of the first gas and the second gas flows, a gas supply unit which is positioned at one side of the inner pipe and to which the at least one of the first gas and the second gas is supplied, and a gas emission portion which is positioned at the other side of the inner pipe and from which the at least one of the first gas and the second gas is emitted.

The first iron source may include an ore-based iron source, and the second iron source may include scrap.

According to one embodiment of the present invention for solving the above problem, a method of operating an electric furnace includes inputting an iron source into an electric furnace including an electrode unit, applying power to the electrode unit to melt the iron source, and blowing oxygen into the electric furnace to perform refining, wherein, in the melting of the iron source, the electrode unit emits a first gas, and in the refining thereof, the electrode unit emits a second gas that is different from the first gas.

The first gas may include an inert gas, and the second gas may include a reducing gas.

The electrode unit may include a first AC electrode rod, a second AC electrode rod, and a third AC electrode rod.

Each of the first AC electrode rod, the second AC electrode rod, and the third AC electrode rod may emit at least one of the first gas and the second gas from within each of the first AC electrode rod, the second AC electrode rod, and the third AC electrode rod.

According to one embodiment of the present invention for solving the above problem, a method of operating an electric furnace is a method of operating an electric furnace which includes an electrode rod and in which a space for accommodating at least one of an iron source, pig iron, and slag is defined therein, the method including emitting, by the electrode rod, a first gas including an inert gas, and emitting, by the electrode rod, a second gas including a reducing gas, wherein, in the emitting of the first gas, the one end portion of the electrode rod is exposed, and in the emitting of the second gas, one end portion of the electrode rod is positioned inside the slag.

The electrode rod may include an inner pipe in which the first gas and the second gas flow, and a gas emission portion positioned at one side of the inner pipe and configured to emit the first gas and the second gas, wherein the gas emission portion may be disposed at the one end portion of the electrode rod.

Specific details of other embodiments are included in the detailed description and drawings.

### Advantageous Effects

According to a method of operating an electric furnace according to one embodiment, even when direct reduced iron is used in an electric furnace, iron oxide (FeO) included in slag can be effectively reduced, and a molten steel collection rate can be improved.

According to a method of operating an electric furnace according to one embodiment, a nitrogen (N₂) content in molten steel of an electric furnace can be adjusted more smoothly.

The effects according to embodiments are not limited to the description exemplified above, and more various effects are included in the present specification.

### DESCRIPTION OF DRAWINGS

FIG. 1 is a schematic cross-sectional view illustrating an electric furnace according to one embodiment.

FIG. 2 is a cross-sectional view of an upper direct current (DC) electrode according to one embodiment.

FIG. 3 is a flowchart of a method of operating an electric furnace according to one embodiment.

FIGS. 4 to 9 are cross-sectional views of process operations of the method of operating an electric furnace according to one embodiment.

FIG. 10 is a graph showing a behavior of nitrogen for each operation of the method of operating an electric furnace.

FIG. 11 is a flowchart of a method of operating an electric furnace according to another embodiment.

FIGS. 12 and 13 are cross-sectional views of process operations of the method of operating an electric furnace according to one embodiment.

### MODES OF THE INVENTION

The advantages and features of the present invention and methods of accomplishing the same will become apparent based on the following description of the embodiments provided in detail, taken in conjunction with the accompanying drawings. However, the present invention is not limited to the embodiments disclosed herein but will be implemented in various forms. The embodiments are provided so that the present invention is completely disclosed, and a person of ordinary skilled in the art can fully understand the scope of the present invention. Therefore, the present invention will be defined only by the scope of the appended claims.

In this specification, when a component (or a region, a layer, a portion, etc.) is referred to as being “on,” “connected to,” or “coupled to” another component, it means that the component may be directly disposed on/connected to/coupled to the other component or that a third component may be disposed therebetween.

Like reference numerals designate like components. Additionally, in the drawings, the thickness, proportions, and dimensions of components are exaggerated for the sake of effective description of technical content.

The term “and/or” includes all of one or more combinations defined by the listed components.

The terms “first,” “second,” and the like may be simply used for description of various constituent elements, but those meanings may not be limited to the restricted meanings. The above terms are used only for distinguishing one constituent element from other constituent elements. For example, a first constituent element may be referred to as a second constituent element, and similarly, the second constituent element may be referred to as the first constituent element without departing from the scope of the present disclosure. An expression used in the singular encompasses the expression of the plural, unless it has a clearly different meaning in the context thereof.

In addition, terms such as “below,” “lower,” “on,” and “upper” are used to describe a relationship of configurations shown in the drawing. These terms describe a relative concept based on an orientation shown in the drawing.

Unless otherwise defined, all terms (including technical and scientific terms) used herein have the same meaning as terms commonly understood by those skilled in the art to which the present disclosure pertains. In addition, it will be further understood that terms, such as those defined in commonly used dictionaries, should be interpreted as having a meaning that is consistent with their meaning in the context of the relevant art and will not be interpreted in an idealized or overly formal sense unless expressly defined so herein.

The term “comprise” or “has” is used to specify existence of a feature, a number, a process, an operation, a constituent element, a part, or a combination thereof, and it will be understood that existence or additional possibility of one or more other features or numbers, processes, operations, constituent elements, parts, or combinations thereof should not be excluded in advance.

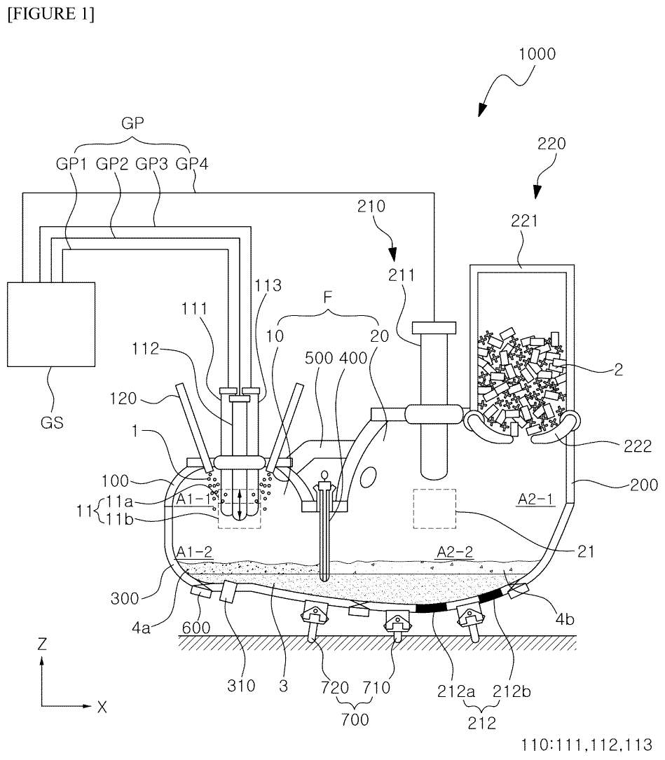

FIG. 1 is a schematic cross-sectional view illustrating an electric furnace according to one embodiment.

Referring to FIG. 1, an electric furnace 1000 according to one embodiment may include a first upper cell 100, a second upper cell 200, a lower cell 300, a partition unit 400, an exhaust gas duct 500, a gas converter device 600, and a tilting device 700.

The electric furnace 1000 may have a dual furnace structure which constitutes one body and in which the lower cell 300 is shared. In the electric furnace 1000, the first upper cell 100 and the second upper cell 200 may share the lower cell 300 and may be connected to the lower cell 300.

The electric furnace 1000 may further include a first melting furnace 10 and a second melting furnace 20 which can melt different iron sources. The first upper cell 100 and the lower cell 300 may constitute the first melting furnace 10 and may define a first upper space A1-1 and a first lower space A1-2 of the first melting furnace 10. The second upper cell 200 and the lower cell 300 may constitute the second melting furnace 20 and may define a second upper space A2-1 and a second lower space A2-2 of the second melting furnace 20.

The electric furnace 1000 may include a dual melting furnace F formed by structurally combining at least portions of the first melting furnace 10 and the second melting furnace 20. The dual melting furnace F may have a structure in which the upper cells 100 and 200 of the first melting furnace 10 and the second melting furnace 20 are provided separately, and one lower cell 300 is provided. The first melting furnace 10 and the second melting furnace 20 may be coupled to each other to share an internal space defined as the upper cells 100 and 200 and the lower cell 300.

The lower cell 300 may include a tapping hole 310 through which a molten metal 3 and/or slags 4a and 4b of the first melting furnace 10 and the second melting furnace 20 may be tapped. The tapping hole 310 may be disposed in the first melting furnace 10.

However, an arrangement position of the tapping hole 310 is not limited to that which has been shown, and the tapping hole 310 may also be disposed in the second melting furnace 20. Alternatively, the tapping hole 310 may be formed in each of the first melting furnace 10 and the second melting furnace 20.

The first melting furnace 10 may have a space therein, in which a first iron source 1, first slag 4a, and the molten metal 3 may be accommodated. The first melting furnace 10 may be charged with the first iron source 1 to melt the first iron source 1. The first iron source 1 may be continuously input into the first melting furnace 10 by an iron source supply unit 120. The first melting furnace 10 may include a continuous melting structure capable of controlling energy input according to an input speed of the first iron source 1.

Although not limited thereto, the first iron source 1 may include ore-based iron sources (ore-based metallics (OBMs) such as iron oxide, direct reduced iron (DRI), hot briquetted iron (HBI), pig iron (PI), granulated pig iron (GPI), low reduced iron (LRI), and the like) and may also include some scrap.

The first melting furnace 10 may include a first slag door 11. Thus, the first slag 4a inside the first melting furnace 10 may be selectively discharged through the first slag door 11. Accordingly, a level of the first slag 4a inside the first melting furnace 10 may be controlled.

The first slag door 11 may be provided as a plurality of doors along a perimeter of the first melting furnace 10 near a boundary between the first upper cell 100 and the lower cell 300. The first slag door 11 may include an upper door 11a that opens upward (at one side of a Z-axis) and a lower door 11b that opens downward (at the other side of the Z-axis). That is, the first slag door 11 may be formed as a double door.

However, a structure of the first slag door 11 is not limited to that described above, and the first slag door 11 may be implemented as a single door to perform an opening/closing operation.

The second melting furnace 20 may have a space therein, in which a second iron source 2, second slag 4b, and the molten metal 3 may be accommodated. The molten metal 3 may be accommodated in each of the first melting furnace 10 and the second melting furnace 20.

The second melting furnace 20 may be charged with the second iron source 2, which is different from the first iron source 1, to melt the second iron source 2. The second iron source 2 may be preheated through a preheating supply unit 220 before being input into the second melting furnace 20. Accordingly, the operating speed and efficiency of the second melting furnace 20 may be improved.

Although not limited thereto, the second iron source 2 may include scrap and may also include some high fineness ore-based iron sources.

The second melting furnace 20 may include a second slag door 21. Through the second slag door 21, the second slag 4b inside the second melting furnace 20 may be selectively discharged. Thus, a level of the second slag 4b inside the second melting furnace 20 may be controlled.

The second slag door 21 may be provided as a plurality of doors along a perimeter of the second melting furnace 20 near a boundary between the second upper cell 200 and the lower cell 300. The second slag door 21 may include a form that may be resealed after being opened during operation.

The first upper cell 100 may include a first electrode unit 110 and at least one iron source supply unit 120.

The first electrode unit 110 may be disposed in the first melting furnace 10. The first electrode unit 110 may penetrate the first upper cell 100 and may be at least partially inserted into the first upper space A1-1 of the first melting furnace 10. The first electrode unit 110 may generate arc heat, and the first iron source 1 charged into the first melting furnace 10 may be melted through the arc heat.

The first electrode unit 110 may include first to third alternating current (AC) electrode rods 111, 112, and 113. Through the first to third AC electrode rods 111, 112, and 113, the first electrode unit 110 may apply a three-phase AC current. The first to third AC electrode rods 111, 112, and 113 may be connected to a power source (not shown) capable of providing power.

The first electrode unit 110 may be connected to a gas supply pipe GP. Specifically, the first to third AC electrode rods 111, 112, and 113 may be connected to first to third gas supply pipes GP1, GP2, and GP3, respectively.

Through the first to third gas supply pipes GP1, GP2, and GP3, the first to third AC electrode rods 111, 112, and 113 may receive various types of gases from a gas storage tank GS. The gas storage tank GS may include a plurality of sub-tanks which store different types of gases.

The first to third AC electrode rods 111, 112, and 113 may emit different gases according to operations of operating the electric furnace 1000. Thus, each operation of operating the electric furnace 1000 may be performed more smoothly. A detailed description thereof will be provided below.

The iron source supply units 120 may be radially disposed with respect to a center of the first electrode unit 110. The iron source supply unit 120 may supply the first iron source 1 to the first melting furnace 10. A plurality of iron source supply units 120 may continuously supply the first iron source 1 to three hot spots formed between the first to third AC electrode rods 111, 112, and 113, thereby improving melting efficiency.

The second upper cell 200 may be disposed to be parallel to the first upper cell 100. The second upper cell 200 may include a second electrode unit 210 and the preheating supply unit 220.

The second electrode unit 210 may be disposed in the second melting furnace 20. The second electrode unit 210 may penetrate the first upper cell 100 and may be at least partially inserted into the second upper space A2-1 of the second melting furnace 20. The second electrode unit 210 may generate arc heat, and the second iron source 2 charged into the second melting furnace 20 may be melted through the arc heat.

The second electrode unit 210 may include an upper direct current (DC) electrode 211 and a lower DC electrode 212. The upper DC electrode 211 and the lower DC electrode 212 may be disposed to face each other. The upper DC electrode 211 and the lower DC electrode 212 may cause a current to flow and may generate an arc.

The lower DC electrode 212 may include a first lower electrode 212a and a second lower electrode 212b. The first lower electrode 212a may be disposed to face the upper DC electrode 211 in a longitudinal direction of the upper DC electrode 211. The second lower electrode 212b may be positioned to be biased toward the preheating supply unit 220 with respect to the upper DC electrode 211.

Immediately after the second iron source 2 is supplied to the second melting furnace 20, the second electrode unit 210 may cause a current to flow between the upper DC electrode 211 and the second lower electrode 212b. After the melting of the second iron source 2 is completed, the second electrode unit 210 may cause a current to flow between the upper DC electrode 211 and the first lower electrode 212a.

The upper DC electrode 211 may selectively create a flow path with different lower electrodes according to whether the second iron source 2 has been melted, thereby controlling an input flow of electric energy to induce an effective melting operation.

The upper DC electrode 211 may be connected to a fourth gas supply pipe GP4 of the gas supply pipe GP. Through the fourth gas supply pipe GP4, the upper DC electrode 211 may receive various types of gases from the gas storage tank GS.

The upper DC electrode 211 may eject different gases according to operations of operating the electric furnace 1000. Thus, each operation of operating the electric furnace 1000 may be performed more smoothly. A detailed description thereof will be provided below.

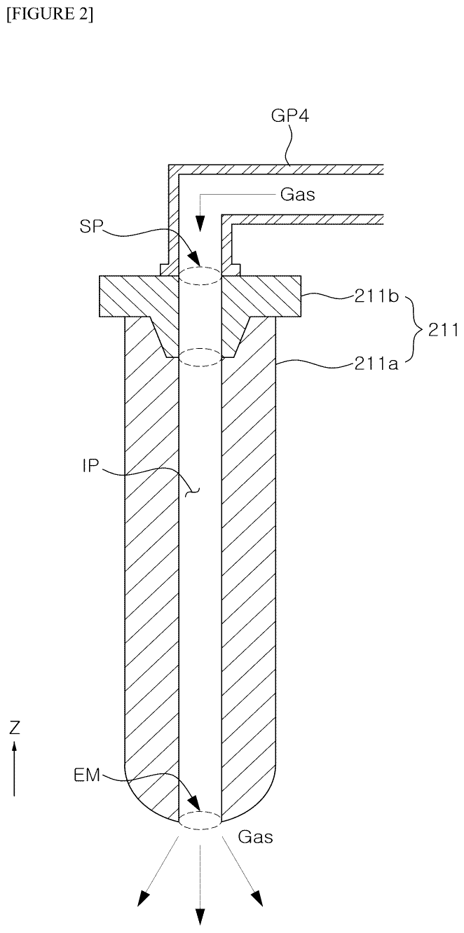

The first to third AC electrodes 111, 112, and 113 and the upper DC electrode 211 may each include a space therein, in which gas may flow, and may eject gas through the space. For a detailed description thereof, reference is made to FIG. 2.

FIG. 2 is a cross-sectional view of the upper DC electrode 211 according to one embodiment.

In FIG. 2, the upper DC electrode 211 will be mainly described, but the description of the upper DC electrode 211 may substantially be equally applied to each of the first to third AC electrode rods 111, 112, and 113.

Referring to FIG. 2, the upper DC electrode 211 may be connected to the fourth gas supply pipe GP4 and may receive gas from the fourth gas supply pipe GP4. The upper DC electrode 211 may emit gas received from the internal space to the outside.

The upper DC electrode 211 may emit different gases according to an operating operation. Gas emitted by the upper DC electrode 211 may be at least one selected from an inert gas, a reducing gas, and a heat source gas.

Although not limited thereto, the inert gas may include argon (Ar) gas, and each of the reducing gas and the heat source gas may include at least one selected from hydrogen (H₂) gas, carbon dioxide (CO₂) gas, and methane (CH₄) gas.

The upper DC electrode 211 may include an electrode body 211a and a line fastening portion 211b that are coupled to each other. The line fastening portion 211b may include a screw thread, and the screw thread may be inserted into the electrode body 211a so that the electrode body 21a and the line fastening portion 211b may be connected to each other.

However, the structure of the upper DC electrode 211 is not limited thereto, and the upper DC electrode 211 may also be implemented in a structure in which an upper portion of the electrode body 211a is inserted into and screw-connected to the line fastening portion 211b.

The electrode body 211a may receive power to actually generate arc heat. The line fastening portion 211b may connect the fourth gas supply pipe GP4 and the electrode body 211a and may allow gas to be supplied toward the electrode body 211a.

The upper DC electrode 211 may define an inner pipe IP, a gas supply unit SP, and a gas emission portion EM. The inner pipe IP may be defined by the electrode body 211a and the line fastening portion 211b.

The inner pipe IP may be defined to penetrate the upper DC electrode 211 in the longitudinal direction of the upper DC electrode 211. The inner pipe IP may penetrate the electrode body 211a and the line fastening portion 211b and may provide a space in which gas may flow. The inner pipe IP may extend in the longitudinal direction (Z-axis direction) of the upper DC electrode 211.

The gas supply unit SP may be positioned at one side of the inner pipe IP in the Z-axis direction and may receive gas from the fourth gas supply pipe GP4. The gas emission portion EM may be positioned at the other side of the inner pipe IP in the Z-axis direction and may emit gas flowing in the inner pipe IP to the outside of the upper DC electrode 211. The gas emission portion EM may be positioned at the other end portion of the upper DC electrode 211 in the longitudinal direction (Z-axis direction).

Referring again to FIG. 1, the preheating supply unit 220 may store the second iron source 2 and may preheat the second iron source 2 before the second iron source 2 is charged into the second melting furnace 20. The preheating supply unit 220 may include a finger type shaft furnace. In this case, the maintenance and operation of the preheating supply unit 220 may be made easier.

By using waste heat generated in the first melting furnace 10 or the second melting furnace 20, the preheating supply unit 220 may preheat the second iron source 2 stored therein. In this case, the waste heat may be supplied to the preheating supply unit 220 in the form of exhaust gas.

The preheating supply unit 220 may include a preheating chamber 221 and a chamber door 222. The preheating supply unit 220 may be disposed at an upper portion of the second melting furnace 20 (at one side thereof in the Z-axis direction, that is, a direction opposite to gravity). The second melting furnace 20 including the second upper cell 200 and the lower cell 300 may include the preheating supply unit 220.

The preheating chamber 221 may extend in the Z-axis direction and may have a storage space capable of storing the second iron source 2. The preheating chamber 221 may have a cylindrical shape or a polygonal barrel shape. One or more charging gates capable of charging the second iron source 2 may be disposed at an upper portion or on side surfaces of the preheating chamber 221.

The chamber door 222 may be positioned at a lower side the preheating chamber 221 (at the other side thereof in the Z-axis direction, that is, the direction of gravity) to selectively open the lower side of the preheating chamber 221. Accordingly, scrap accommodated inside the preheating chamber 221 may be selectively supplied to the second melting furnace 20.

An opening/closing rate of the chamber door 222 may be adjusted. Accordingly, an amount of scrap supplied to the second melting furnace 20 may be selectively controlled.

The partition unit 400 may positioned between the first upper cell 100 and the second upper cell 200 and may extend in the Z-axis direction. The partition unit 400 may be disposed between the first melting furnace 10 and the second melting furnace 20.

The partition unit 400 may include a refractory material to withstand a temperature of a molten metal or slag. The partition unit 400 may be connected to the first upper cell 100 and the second upper cell 200 to be replaceable.

The partition unit 400 may be lifted and lowered and may selectively separate the first lower space A1-2 of the first melting furnace 10 from the second lower space A2-2 of the second melting furnace 20.

The partition unit 400 may separate the first slag 4a positioned inside the first melting furnace 10 from the second slag 4b positioned inside the second melting furnace 20. The first slag 4a may be reducing slag based on ore-based iron sources (OBMs), and the second slag 4b may be oxidizing slag based on scrap.

Even when the first slag 4a and the second slag 4b have different properties, the first slag 4a and the second slag 4b may be separated from each other by the partition unit 400 and thus may be disposed together in the dual melting furnace F without being mixed with each other. Furthermore, the functions of the first slag 4a and the second slag 4b of different types thereof may be simultaneously utilized, and the efficiency of an overall operating process may be improved.

The exhaust gas duct 500 may be in the form of a duct, may be disposed outside the first upper cell 100 and the second upper cell 200, and may allow the first upper cell 100 to communicate with the second upper cell 200.

In other words, the exhaust gas duct 500 may allow the first upper space A1-1 of the first melting furnace 10 to communicate with the second upper space A2-1 of the second melting furnace 20. Through the exhaust gas duct 500, high-temperature exhaust gas generated in the first melting furnace 10 may be supplied to the second melting furnace 20.

The gas converter device 600 may be disposed in the lower cell 300 to emit gas. A plurality of gas converter devices 600 may be provided. For example, the plurality of gas converter devices 600 may be disposed in the lower cell 300 overlapping each of the first melting furnace 10 and the second melting furnace 20.

Gas emitted by the gas converter device 600 may include at least one of an inert gas or a heat source gas.

Through the gas converter device 600, a flow of the molten metal 3 may be controlled or fuel and raw material may be input into the dual melting furnace F. One or more gas inlets of the gas converter blow device 600 may be provided, and the type, size, number, position, and the like of the gas inlets may be changed in various ways as needed.

The tilting device 700 may tilt the electric furnace 1000, thereby discharging the molten metal 3, the first slag 4a, and the second slag 4b inside thereof to the outside.

The tilting device 700 may include a support cylinder 710 that maintains a center of the electric furnace 1000 and a driving cylinder 720 that may move up/down. A plurality of driving cylinders 720 may be provided. Through the support cylinder 710 and the driving cylinder 720, the electric furnace 1000 may be tilted in a direction intersecting the Z-axis direction.

Hereinafter, a method of operating an electric furnace of the present invention will be described.

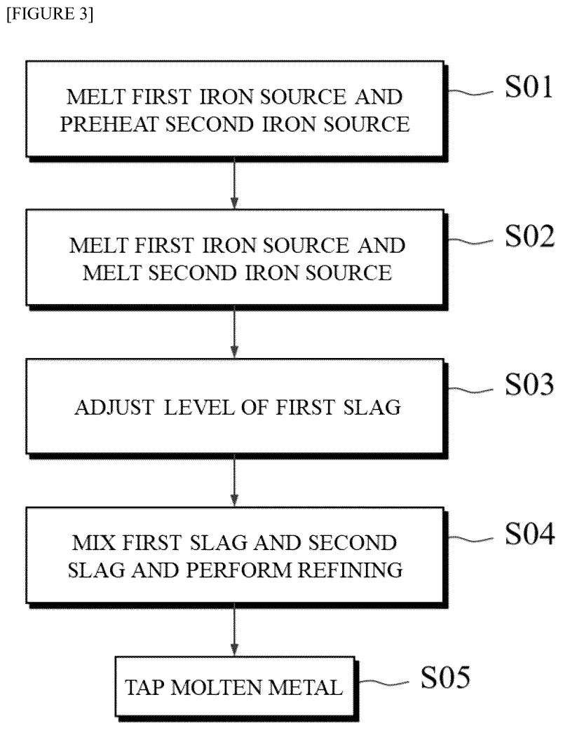

FIG. 3 is a flowchart of the method of operating an electric furnace according to one embodiment.

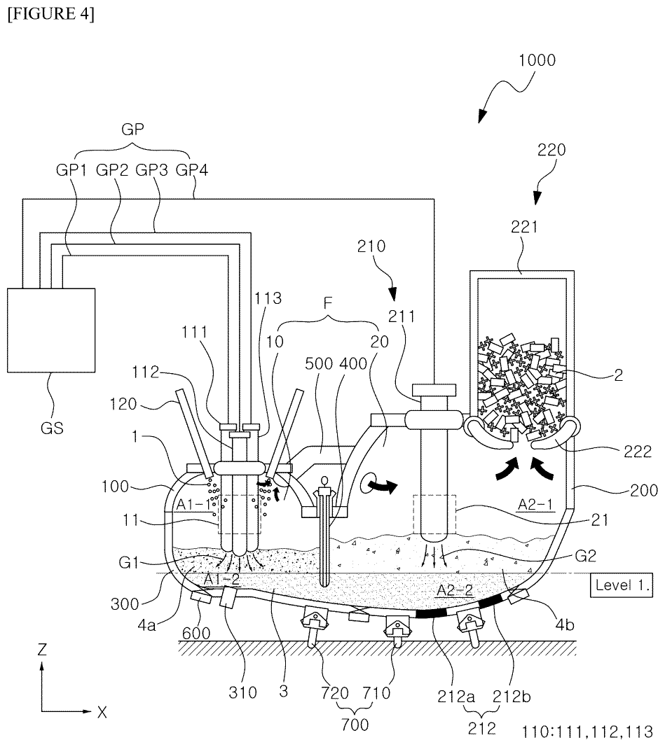

FIGS. 4 to 9 are cross-sectional views of process operations of the method of operating an electric furnace according to one embodiment.

Referring to FIGS. 3 and 4, first, a method of operating the electric furnace 1000 according to one embodiment may include operation S01 of melting the first iron source 1 and preheating the second iron source 2.

Specifically, the melting of the first iron source 1 may be performed in the first melting furnace 10, and the preheating of the second iron source 2 may be performed in the second melting furnace 20. The melting of the first iron source 1 and the preheating of the second iron source 2 may be simultaneously performed.

The first melting furnace 10 may continuously receive the first iron source 1 through the plurality of iron source supply units 120 to melt the first iron source 1. The second melting furnace 20 may preheat the second iron source 2 while maintaining the foaming of the second slag 4b.

The preheating of the second iron source 2 may be performed using waste heat through arcing of at least one of the first melting furnace 10 and the second melting furnace 20. For example, waste heat of the first melting furnace 10 generated in a process of melting the first iron source 1 may be supplied to the second melting furnace 20 through the exhaust gas duct 500 together with exhaust gas, and the preheating of the second iron source 2 may be performed using waste heat of the second melting furnace 20.

The partition unit 400 may be lowered as much as possible to separate the first melting furnace 10 from the second melting furnace 20. In other words, the partition unit 400 may separate the first slag 4a from the second slag 4b.

In operation S01 of melting the first iron source 1 and preheating the second iron source 2, the first electrode unit 110 may emit the first gas G1, and the second electrode unit 210 may emit second gas G2.

The first gas G1 may include a reducing gas. Although not limited thereto, the reducing gas may include at least one selected from hydrogen (H₂) gas and methane (CH₄) gas.

The first iron source 1 may be introduced into the first melting furnace 10 by including a large amount of iron oxide (FeO). When the first electrode unit 110 emits the first gas G1, even when a large amount of iron oxide (FeO) is introduced, iron oxide (FeO) may be more easily reduced.

In addition, when arcing is performed at the first electrode unit 110, a reducing gas emitted from the first electrode unit 110 may be converted into plasma by arc heat. Activation energy of the reducing gas converted into plasma may be lowered, and the efficiency of a reduction reaction thereof may be improved.

When the first gas G1 includes the reducing gas, the first electrode unit 110 may be at least partially submerged in the first slag 4a. The other end portion of the first electrode unit 110 in the Z-axis direction may be submerged in the first slag 4a.

Specifically, in a state in which a gas emission portion of each of the first to third AC electrode rods 111, 112, and 113 of the first electrode unit 110 is submerged in the first slag 4a, such as the gas emission portion EM (see FIG. 2) of the upper DC electrode 211 (see FIG. 2), the first to third AC electrode rods 111, 112, and 113 may emit the first gas G1.

When the gas emission portion of each of the first to third AC electrode rods 111, 112, and 113 is positioned outside the first slag 4a without being submerged in the first slag 4a, the first to third AC electrode rods 111, 112, and 113 may emit an inert gas.

In this case, an inert gas atmosphere may be formed around the first to third AC electrode rods 111, 112, and 113, and a sealing function may be performed at a periphery of an area in which an arc is generated.

That is, when the first to third AC electrodes 111, 112, and 113 emit an inert gas, nitrogen (N₂) in the atmosphere may be suppressed or prevented from being picked up by the molten metal 3 by an arc stream.

The second gas G2 may include at least one selected from an inert gas and a reducing gas. Although not limited thereto, the second gas G2 may include argon (Ar) gas and carbon dioxide (CO₂) gas or may include methane (CH₄) gas.

While the first iron source 1 is melted in the first melting furnace 10, impurities due to the melting of the first iron source 1 may flow into the second melting furnace 20. In this case, in the second melting furnace 20, oxidative refining of inflowing impurities may be performed through oxygen (O₂).

The second gas G2 may include a reducing gas and thus may reduce iron oxide (FeO) generated by oxygen (O₂) used in refining. In addition, the second gas G2 may further include an inert gas to control a balance between oxidative refining by oxygen (O₂) and reduction of iron oxide (FeO) generated by oxidative refining.

Next, referring to FIGS. 3, 5, and 6, the method of operating the electric furnace 1000 may include operation S02 of melting the first iron source 1 and melting the second iron source 2.

Specifically, the melting of the first iron source 1 may be performed in the first melting furnace 10, and the melting of the second iron source 2 may be performed in the second melting furnace 20. The melting of the first iron source 1 and the melting of the second iron source 2 may be simultaneously performed. The melting of the first iron source 1 may continuously performed while the second iron source 2 is preheated and melted.

Since the first iron source 1 is melted in the first melting furnace 10, a level of the molten metal 3 may rise from level 1 to level 2. When the rising level (level 2) reaches a level at which the second iron source 2 is completely submerged, the chamber door 222 may be opened to charge the second iron source 2 preheated in the preheating chamber 221.

The preheated second iron source 2 is charged according to the level of the molten metal 3, thereby improving the melting efficiency of the second iron source. In addition, a time during which the second iron source 2 and the molten metal 3 are exposed without being covered by the second slag 4b may be minimized, thereby suppressing or preventing nitrogen (N) from being picked up by an arc current.

The partition unit 400 may be lifted according to the level of the molten metal 3. Accordingly, a flow channel of the molten metal 3 between the lower space A1-2 of the first melting furnace 10 and the lower space A2-2 of the second melting furnace 20 may be expanded.

Since the flow channel expands, material exchange and heat exchange can become more active. In addition, the first electrode unit 110 of the first melting furnace 10 and the second electrode unit 210 of the second melting furnace 20 may also be lifted according to the level of the molten metal 3.

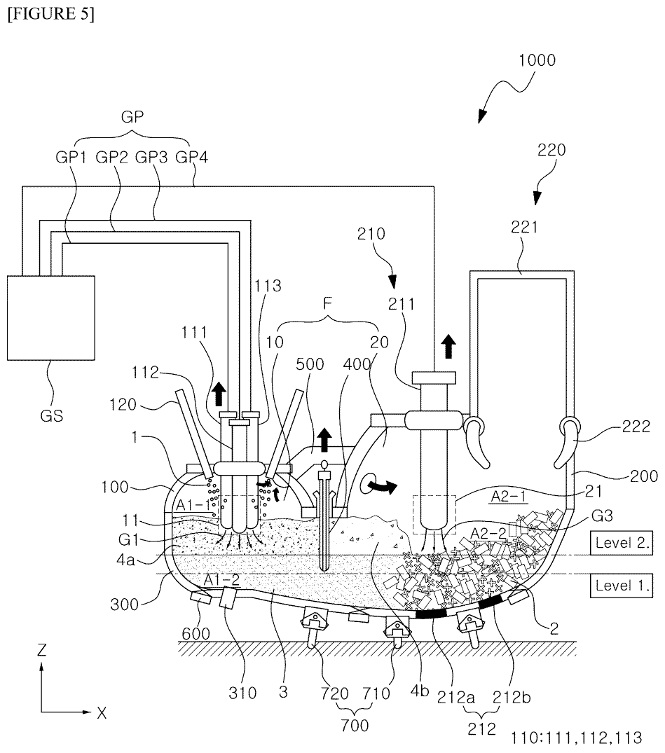

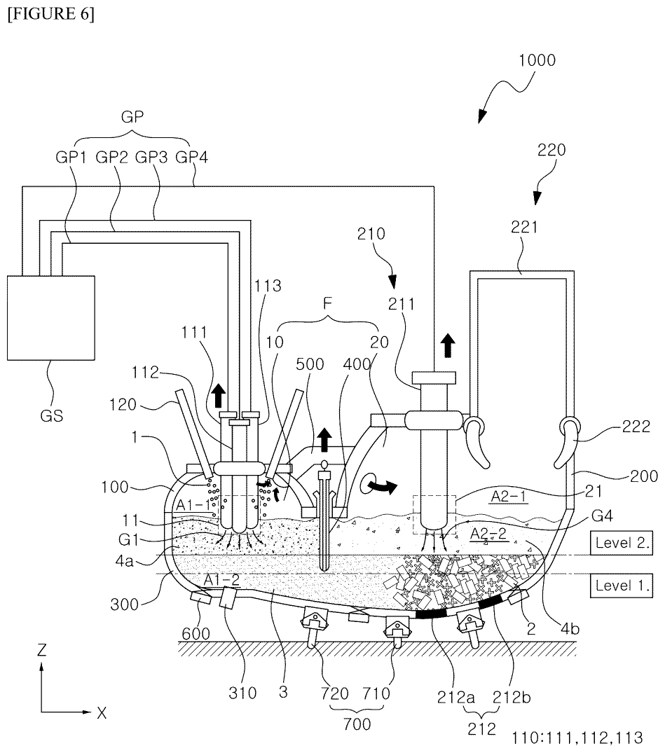

In operation S02 of melting the first iron source 1 and melting of the second iron source 2, the first electrode unit 110 may emit the first gas G1. The second electrode unit 210 may emit the third gas G3 (see FIG. 5) or the fourth gas G4 (see FIG. 6) that is different from the first gas G1 according to an operation of charging the second iron source 2.

Specifically, the operation of melting the second iron source 2 may include an initial charging operation of the second iron source (see FIG. 5) and a subsequent charging operation of the second iron source 2 (see FIG. 6).

In the initial charging operation of the second iron source 2, the second slag 4b may be separated and dispersed by the second iron source 2 being dropped from the preheating chamber 221. Accordingly, portions of the molten metal 3 and the second iron source 2 may not be covered by the second slag 4b and may be exposed.

Additionally, the upper DC electrode 211 may be exposed without being submerged in the second slag 4b and the molten metal 3. An end portion of the upper DC electrode 211 and the other end portion thereof in the Z-axis direction may be exposed. In this case, the gas emission portion EM of the upper DC electrode 211 may be exposed without being submerged in the second slag 4b.

In this case, the second electrode unit 210 may emit the third gas G3. The third gas G3 may include an inert gas. The present invention is not limited thereto, but for example, the inert gas may include argon (Ar) gas.

The second electrode unit 210 emits the third gas G3, thereby suppressing or preventing nitrogen (N) from being picked up by an arc generated by the second electrode unit 210.

In other words, the second electrode unit 210 emits the third gas G3, and thus a third gas G3 atmosphere may be generated in a space between the upper DC electrode 211 and the molten metal 3. The third gas G3 atmosphere may be generated at a periphery of area in which an arc is generated.

An arc stream generated between the upper DC electrode 211 and the lower DC electrode 212 may be sealed by the third gas G3.

Accordingly, even when the upper DC electrode 211, the second iron source 2, and the molten metal 3 are exposed without being submerged in the second slag 4b, it is possible to suppress or prevent nitrogen (N) from flowing into the molten metal 3 by an arc stream.

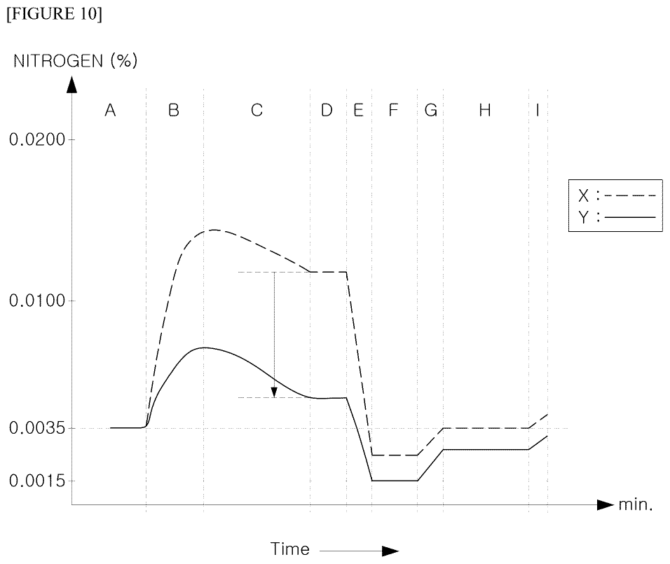

For a more detailed description thereof, reference is made to FIG. 10.

FIG. 10 is a graph showing a behavior of nitrogen for each operation of the method of operating an electric furnace.

Referring further to FIG. 10, the graph of FIG. 10 has a horizontal axis and a vertical axis. The horizontal axis represents a flow (time) of an electric furnace operating process, and the vertical axis represents a nitrogen content (%).

The graph in FIG. 10 shows the behavior of nitrogen (N) when an iron source charged into a melting furnace includes scrap and DRI, and a ratio of the scrap to the DRI is 1:4.

This may be applied to an operating process performed in the electric furnace 1000 of the present invention. However, this is merely an example of an operating process that may be performed in the electric furnace 1000, and the present invention is not limited thereto.

In the graph of FIG. 10, graph X represents a case in which the electrode units 110 and 210 do not emit an inert gas, and graph Y represents a case in which an arc stream is sealed by an inert gas emitted by the electrode units 110 and 210.

The graph of FIG. 10 includes operations A, B, C, D, E, F, G, H, and I according to an electric furnace operating process.

Operation A is an operation of heating the electrode units 110 and 210 before melting the iron source inside the melting furnace. In operation A, it can be confirmed that the nitrogen contents (%) of graph X and graph Y are 0.0035%.

Operation B is an operation in which the iron source is melted by arc heat. In operation B, it can be confirmed that the nitrogen contents (%) of graph X and graph Y increase.

Operation C is an operation in which the slags 4a and 4b are formed as melting is performed. In operation C, it can be confirmed that the nitrogen contents (%) of graph X and graph Y decrease.

Operation D is an operation of heating the melting furnace to prepare for a decarburization process. In operation D, it can be confirmed that the nitrogen contents (%) of graph X and graph Y may be maintained.

Operation E is an operation in which a decarbonization process is performed. In operation E, it can be confirmed that the nitrogen contents (%) of graph X and graph Y decrease.

Operation F is an operation in which a new iron source is charged. In operation F, it can be confirmed that the nitrogen contents (%) of graph X and graph Y are maintained.

Operation G is an operation of tapping a molten metal. In operation G, it can be confirmed that the nitrogen contents (%) of graph X and graph Y increase.

Operation H is an operation of storing the discharged molten metal. In operation H, it can be confirmed that the nitrogen contents (%) of graph X and graph Y are maintained.

Operation I is an operation of casting the molten metal. In operation I, it can be confirmed that the nitrogen contents (%) of graph X and graph Y increase.

As compared to graph X, in graph Y, it can be confirmed that the nitrogen content (%) increases relatively slightly in operation B. That is, in operation B, as an arc stream is sealed by an inert gas being emitted from the electrode units 110 and 210, nitrogen (N) may be suppressed or prevented from being picked up.

In addition, when nitrogen (N) is suppressed or prevented from being picked up in operation B, it can be confirmed that even when a subsequent process continues, the nitrogen content of graph Y is lower than the nitrogen content of graph X.

Referring again to FIGS. 3 and 6, in a subsequent charging operation in which the second iron source 2 is completely submerged in the molten metal 3, the second electrode unit 210 may emit the fourth gas G4.

When the fourth gas G4 is emitted, an end portion of the upper DC electrode 211 and the other end portion thereof in the Z-axis direction may be submerged inside the second slag 4b. That is, the gas emission portion EM of the upper DC electrode 211 may be submerged inside the second slag 4b.

The fourth gas G4 may include at least one of an inert gas and a reducing gas. The reducing gas may include at least one selected from carbon dioxide (CO₂) gas, hydrogen (H₂) gas, and methane (CH₄) gas.

For example, the fourth gas G4 may include argon (Ar) gas and carbon dioxide (CO₂) gas or may include methane (CH₄) gas.

When the fourth gas G4 includes carbon dioxide (CO₂) gas, the second slag 4b may be more smoothly formed. When the fourth gas G4 includes methane (CH₄) gas or hydrogen (H₂) gas, iron oxide (FeO) that is generated may be more smoothly reduced by oxygen for melting the second iron source 2.

In addition, when the fourth gas G4 further includes an inert gas, a concentration of a reducing gas is adjusted, thereby controlling a balance between melting performance and reducing performance.

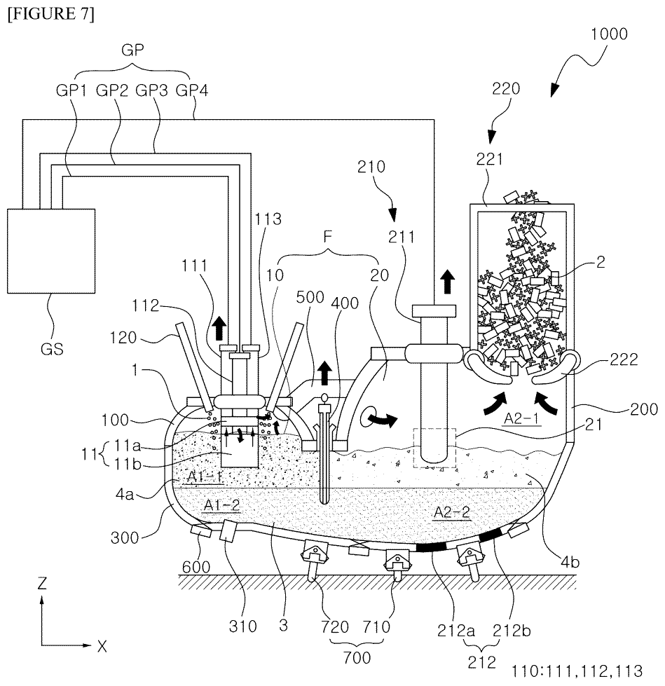

Next, referring to FIGS. 3 and 7, the method of operating the electric furnace 1000 may include operation S03 of adjusting a level of the first slag 4a.

Specifically, in the first melting furnace 10, the upper door 11a of the first slag door 11 may be opened upward. Accordingly, the first slag 4a may be discharged, and the level of the first slag 4a may be adjusted. Thus, the efficiency of refining to be performed subsequently can be improved.

In the second melting furnace 20, melting of the second iron source 2 charged into the molten metal 3 may continue or preheating of a new second iron source 2 supplied to the preheating supply unit 220 may be performed.

Even in this case, the partition unit 400 may be lifted according to the level of the molten metal 3. Accordingly, the flow channel of the molten metal 3 between the lower space A1-2 of the first melting furnace 10 and the lower space A2-2 of the second melting furnace 20 may be further expanded.

Since the flow channel expands, material exchange and heat exchange can become more active. The first electrode unit 110 of the first melting furnace 10 and the second electrode unit 210 of the second melting furnace 20 may also be lifted according to the level of the molten metal 3.

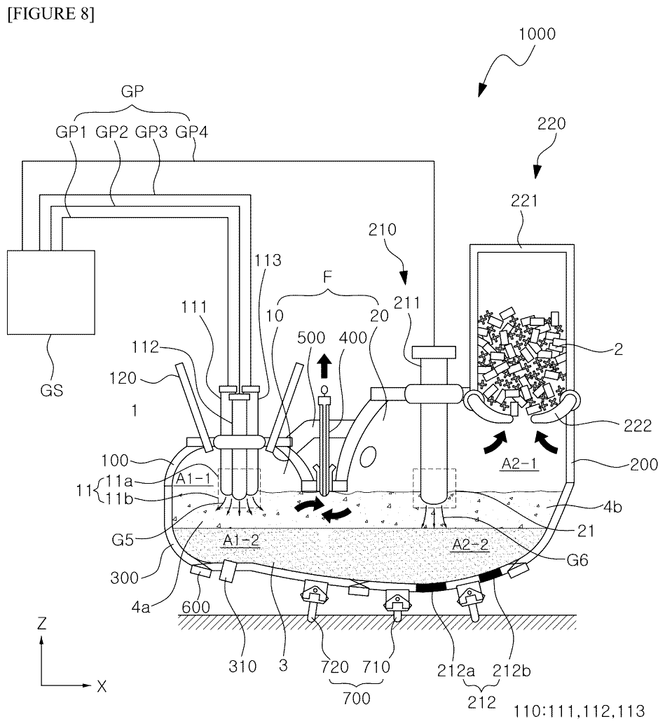

Next, referring to FIGS. 3 and 8, the method of operating the electric furnace 1000 may include operation S04 of mixing the first slag 4a and the second slag 4b and performing refining.

Specifically, the partition unit 400 may be lifted as much as possible to open a space between the first melting furnace 10 and the second melting furnace 20 as much as possible. Accordingly, the first slag 4a and the second slag 4b may be mixed to perform refining.

Since the first slag 4a and the second slag 4b are mixed after a level of the first slag 4a, which is reducing slag, is adjusted, refining efficiency can be improved. In addition, the partition unit 400 may be lifted as much as possible to determine an interface at which a refining reaction may occur, thereby further improving refining efficiency.

After the first slag 4a and the second slag 4b are mixed, oxidative refining using oxygen (O₂) may be performed. Thus, a decarburization reaction and a dephosphorization reaction may occur at a high speed.

The first electrode unit 110 may emit a fifth gas G5, and the second electrode unit 210 may emit a sixth gas G6. Each of the fifth gas G5 and the sixth gas G6 may include a reducing gas.

Although not limited thereto, the reducing gas may include at least one selected from, for example, carbon dioxide (CO₂) gas, methane (CH₄) gas, and hydrogen (H₂) gas. The fifth gas G5 and the sixth gas G6 may emit the same type of gas, but the present invention is not limited thereto.

As the fifth gas G5 and the sixth gas G6 emit a reducing gas, reduction of iron oxide (FeO) produced by oxygen (O₂) used in oxidative refining may be performed. A concentration of the reducing gas emitted by the fifth gas G5 and the sixth gas G6 may be adjusted in consideration of all of an amount of input oxygen (O₂), refining capacity, and reducing capacity.

As the fifth gas G5 and the sixth gas G6 emit the reducing gas, refining of the molten metal 3 and reduction of iron oxide (FeO) may be performed together. In addition, as the concentration of the reducing gas is adjusted, refining capacity and reducing capacity can be adjusted together, and the efficiency of a process can be improved.

During processes of FIGS. 4 to 8, material and heat exchange may occur between the first melting furnace 10 and the second melting furnace 20 through an area not separated by the partition unit 400. Thus, a refining reaction may be continuously performed in the second melting furnace 20, and maximum refining capacity may be secured when the partition unit 400 is lifted as much as possible.

The first melting furnace 10 may reduce a large amount of iron oxide (FeO) introduced from the first iron source 1 by maintaining the first slag 4a until the partition unit 400 is lifted as much as possible to mix the first slag 4a and the second slag 4b.

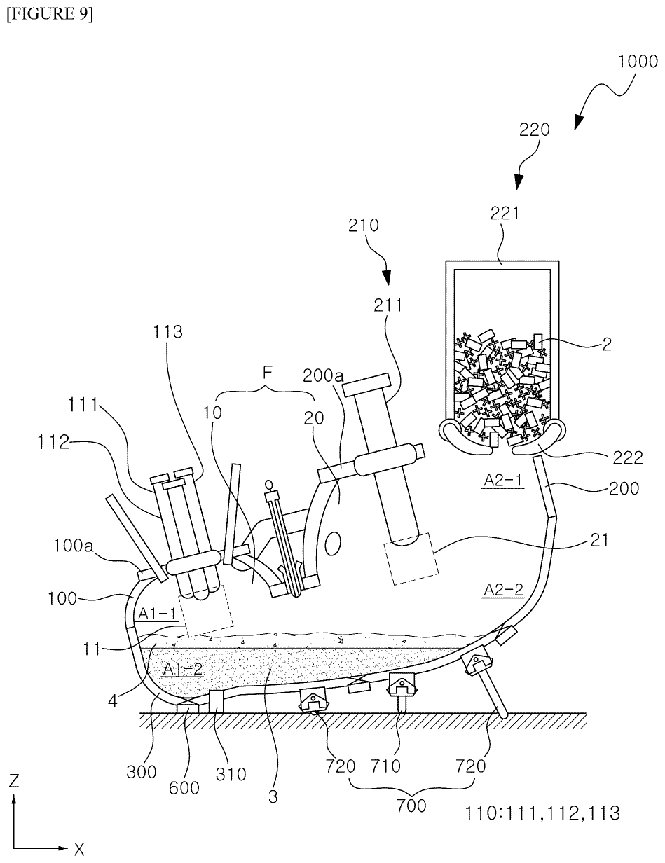

Next, referring to FIGS. 3 and 9, the method of operating the electric furnace 1000 may include operation S05 of tapping the molten metal 3 (S05).

Specifically, the driving cylinder 720 at a side of the second melting furnace 20 may be lifted to tilt the dual melting furnace F. The dual melting furnace F may be tilted toward the first melting furnace 10 in which the tapping hole 310 is formed.

Accordingly, the molten metal 3 and/or slag 4 inside the first melting furnace 10 and the second melting furnace 20 may be tapped more smoothly. Here, the slag 4 may refer to mixed slag in which the first slag 4a and second slag 4b are mixed.

The preheating supply unit 220 may be formed in a form that is separable from the remaining portion of the second upper cell 200. In this case, the dual melting furnace F may be tilted more smoothly.

Since the electric furnace 1000 includes the first melting furnace 10 and the second melting furnace 20 that melt the first iron source 1 and the second iron source 2 which are different from each other, productivity, economic feasibility, and quality can be secured, and carbon neutrality in steel production can be achieved.

Ore-based iron sources (OBMs) and scrap as well as general scrap are simultaneously input into each of the melting furnaces 10 and 20, and the slags 4a and 4b are separated, thereby performing refining while a main raw material is melted.

Operating influence by a large amount of gangue that may be introduced from ore-based iron sources (OBMs) may be separated and discharged in the first melting furnace 10, thereby maintaining appropriate refining conditions. In addition, a large amount of ore-based iron sources (OBMs) may be input into the first melting furnace 10, thereby reducing a tramp component.

In addition, by inputting and operating scrap through the second melting furnace 20 connected to the first melting furnace 10, a complete flat bath operation can be made possible.

The first melting furnace 10 and the second melting furnace 20 can be simultaneously operated, the energy consumption in the preheating of the second iron source 2 in the second melting furnace 20 can be reduced below a level of a general scrap operation, and an operation can be reduced to a level of that of a converter.

The first electrode unit 110 and the second electrode unit 210 emit a reducing gas to reduce the slags 4a and 4b, thereby improving a molten steel collection rate.

TABLE 1

| Classification | First operation | Second operation |
|---|---|---|
| Charging amount (ton) | 168.8 | 168.1 |
| Tapping amount (ton) | 152 | 149 |
| Basic unit of quicklime | 18.2 | 28.3 |
| (kg/ton) | | |
| Basic unit of light burned | 13.4 | 9.5 |
| (kg/ton) | | |
| Input amount of CaO (kg) | 3,029 | 3,940 |
| Total iron in slag (T/Fe) | 16.28% | 23.75% |
| Theoretical amount of | 17,937 | 22,170 |
| produced slag (kg) | | |

In Table 1, a first operation represents a case in which an iron source melted in a melting furnace is 100% scrap, and a second operation represents a case in which an iron source melted in a melting furnace consists of scrap and HBI. The second operation may be substantially the same as the operation of the electric furnace 1000 according to the present embodiment.

The iron source used in the second operation includes scrap and HBI in a ratio of 4:6, but the ratio of the scrap to the HBI is not limited thereto.

The description provided in Table 1 is merely an example of each of the first and second operations, and each operation is not limited thereto.

In the first operation, a charging amount is 168.8 tons, a tapping amount is 152 tons, a basic unit of quicklime is 18.2 kg/ton, a basic unit of light burned is 13.4 kg/ton, an input amount of CaO is 3,029 kg, the total iron in slag is 16.28%, and a theoretical amount of produced slag is 17,937 kg.

In the second operation, a charging amount is 168.1 tons, a tapping amount is 149 tons, a basic unit of quicklime is 28.2 kg/ton, a basic unit of light burned is 9.5 kg/ton, an input amount of CaO is 3,940 kg, the total iron in slag is 23.75%, and a theoretical amount of produced slag is 22,270 kg.

A molten steel collection rate may be represented by Equation 1 below.

$$Molten steel collection rate ( \% ) = ( tapping amount / charging amount ) \times 100 ( \% ) \qquad Equation 1$$

The molten steel collection rate (%) may be calculated by multiplying a value, which is obtained by dividing a tapping amount by a charging amount, by 100.

The molten steel collection rate (%) of the first operation is (152/168.8)×100-90.0%. The molten steel collection rate (%) of the second operation is (149/168.1)×100-88.6%. However, when a reducing gas is emitted through the electrode units 110 and 210 to reduce the slags 4a or 4b, the molten steel collection rate of the second operation may be improved.

An additional steel collection rate of the second operation may be represented by Equation 2 below.

$$Additional steel collection rate ( \% ) = ( theoretical amount of produced slag ( kg ) \times reduction amount of total iron ) / charging amount ( kg ) \times 100 ( \% ) \qquad Equation 2$$

The additional steel collection rate (%) may be calculated by multiplying a value, in which a theoretical amount of produced slag is multiplied by a reduction amount of total iron and divided by a charging amount, by 100.

By a reducing gas emitted through the electrode units 110 and 210, the slags 4a and 4b may be reduced, and the total amount of iron in the slags 4a and 4b may be reduced.

For example, when the total amount of iron of the second operation decreases to 16.28% of the total amount of iron of the first operation, a decrease in the total amount of iron in Equation 2 is 23.75%-16.28%=7.47%.

In this case, the additional steel collection rate of the second operation is (22,270 kg×7.47%)/16,8100 kg=0.98%.

In the second operation, a total molten steel collection rate is 88.6%+0.98%=89.58%.

Since the slags 4a and 4b are reduced by the reducing gas emitted through the electrode units 110 and 210, even when scrap and HBI are used as iron sources, a molten steel collection rate corresponding to that of an operation using only scrap can be secured.

In addition, in the case of the second operation, an amount of input scrap may be smaller in comparison to the first operation, and thus high-quality molten steel with a significantly low tramp element content can be produced.

Hereinafter, other embodiments will be described. In the following embodiments, a description of the same components as those described above will be omitted or will be given briefly, and differences thereof will be mainly described.

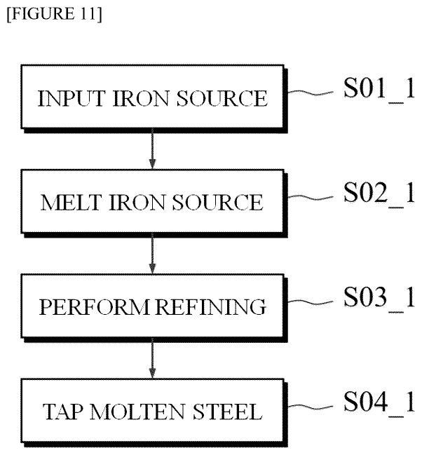

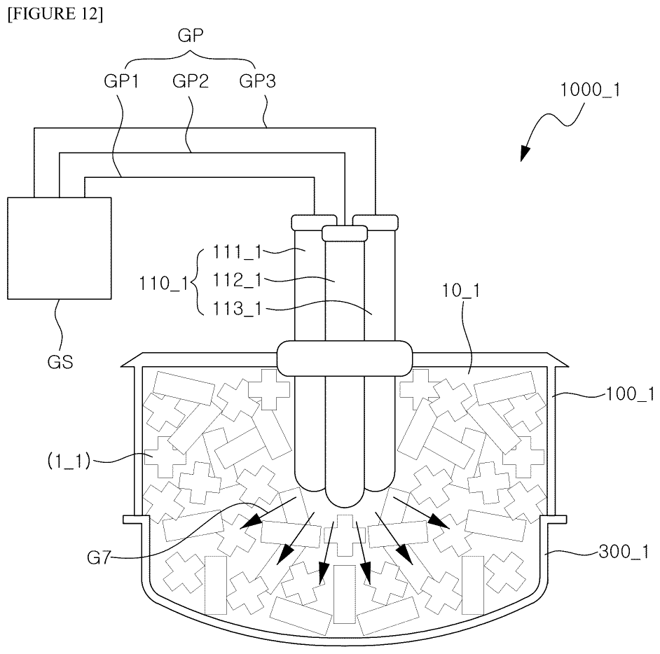

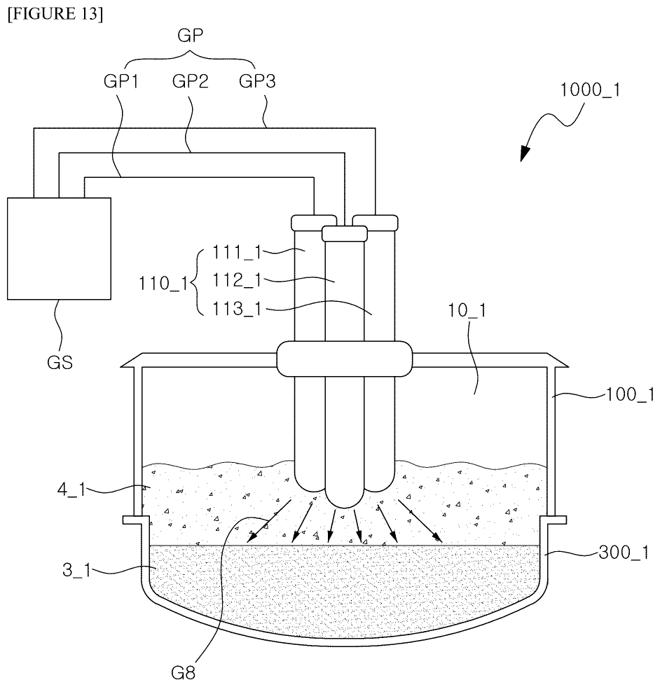

FIG. 11 is a flowchart of a method of operating an electric furnace according to another embodiment. FIGS. 12 and 13 are cross-sectional views of process operations of the method of operating an electric furnace according to one embodiment.

Referring to FIGS. 11 and 12, an electric furnace 1000_1 according to another embodiment differs from that of the one embodiment in that the electric furnace 1000_1 is provided as a single melting furnace rather than the dual melting furnace F (see FIG. 1).

In addition, a method of operating the electric furnace 1000_1 according to another embodiment differs from that of the one embodiment in that the method includes operation S01_1 of inputting an iron source 1_1, operation S02_1 of melting the iron source 1_1, operation S03_1 of performing refining, and operation S04_1 of tapping molten steel.

Specifically, the electric furnace 1000_1 may include an upper cell 100_1, a lower cell 300_1, a melting furnace 10_1 including the upper cell 100_1 and the lower cell 300_1, and an electrode unit 110_1.

The electrode unit 110_1 includes first to third AC electrode rods 111_1, 112_1, and 113_1 which may be respectively connected to first to third gas supply pipes GP1, GP2, and GP3 to receive various types of gases from a gas storage tank GS.

In operation S01_1 of inputting the iron source 1_1, the iron source 1_1 is input into the melting furnace 10_1. The iron source 1_1 may include scrap, but the present invention is not limited thereto. The iron source 1_1 may fill the entire internal volume of the melting furnace 10_1.

In operation S02_1 of melting the iron source 1_1, the electrode unit 110_1 may receive power to generate arc heat. Due to the generated arc heat, the iron source 1_1 may be melted inside the melting furnace 10_1.

The electrode unit 110_1 may emit a seventh gas G7. The seventh gas G7 may include an inert gas. The inert gas may include, for example, argon (Ar) gas, but the present invention is not limited thereto.

The electrode unit 110_1 may be exposed without being submerged in slag 4_1 and a molten metal 3_1. An end portion of the electrode unit 110_1 and the other end portion thereof in a Z-axis direction may be exposed. In this case, a gas emission portion EM (see FIG. 2) of the electrode unit 110_1 may be exposed without being submerged in the slag 4_1.

Since the electrode unit 110_1 emits the seventh gas G7, an inert gas atmosphere may be generated at a periphery of the electrode unit 110_1. Accordingly, even when arcing is performed at the electrode unit 110_1, an inert gas atmosphere may be generated at a periphery of an area in which an arc occurs, and a nitrogen (N) pickup phenomenon can be suppressed or prevented.

Referring to FIGS. 11 and 13, the iron source 1_1 (see FIG. 12) may be melted to form the molten metal 3_1 and the slag 4_1. A periphery of an area in which an arc occurs in the electrode unit 110_1 may be sealed by the molten metal 3_1.

In operation S03_1 of performing the refining, oxygen may be blown into the melting furnace 10_1 to oxidatively refine the molten metal 3_1.

The electrode unit 110_1 may emit an eighth gas G8. The eighth gas G8 may include a reducing gas. The reducing gas may include at least one selected from carbon dioxide (CO₂) gas, hydrogen (H₂) gas, and methane (CH₄) gas, but the present invention is not limited thereto.

The electrode unit 110_1 may be at least partially submerged inside the slag 4_1. The end portion of the electrode unit 110_1 and the other end portion thereof in the Z-axis direction may be submerged inside the slag 4_1. In this case, the gas emission portion EM (see FIG. 2) of the electrode unit 110_1 may be submerged in the slag 4_1.

As the eighth gas G8 is emitted from the electrode unit 110_1, reduction of iron oxide (FeO) that may be generated by oxidative refining may be performed. The reducing gas is converted into plasma, thereby improving the efficiency of a reduction reaction. Accordingly, the efficiency of an entire operating process can be improved.

In operation S04_1 of tapping the molten steel, when a condition of the molten metal 3_1 corresponds to a target condition, the molten metal 3_1 may be tapped from the electric furnace 1000_1 by a moving component.

Even in this case, since different gases are emitted from the electrode unit 110_1 during each operating operation, operating efficiency can be improved, and product quality can be improved.

In the above, although embodiments of the present invention have been described with reference to the accompanying drawings, those skilled in the art may understand that the present invention may be embodied in other specific forms without changing the technical spirit or essential features thereof. Accordingly, it should be understood that the above-described embodiments are exemplary in all respects and not restrictive.

### DESCRIPTIONS OF SYMBOLS

1: first iron source
2: second iron source
3: molten metal
4: slag
10: first melting furnace
20: second melting furnace
100: first upper cell
110: first electrode unit
200: second upper cell
210: second electrode unit
220: preheating supply unit
300: lower cell
400: partition unit
500: exhaust gas duct
600: gas converter device
700: tilting device
1000: electric furnace

1. A method of operating an electric furnace, the method comprising:
melting a first iron source in a first melting furnace in which a first electrode unit is disposed;
preheating a second iron source in a second melting furnace in which a second electrode unit is disposed; and
melting the second iron source in the second melting furnace,
wherein the first melting furnace and the second melting furnace share an internal space,
in the preheating of the second iron source, the second electrode unit emits a first gas, and
in the melting of the second iron source, the second electrode unit emits a second gas that is different from the first gas.

2. The method of claim 1, wherein the first gas includes a reducing gas, and the second gas includes an inert gas.

3. The method of claim 2, wherein the reducing gas includes at least one selected from carbon dioxide (CO₂) gas, methane (CH₄) gas, and hydrogen (H₂) gas, and the inert gas includes argon (Ar) gas.

4. The method of claim 2, wherein the first gas further includes an inert gas.

5. The method of claim 1, wherein the melting of the second iron source includes initial melting and subsequent melting,
in the initial melting, the second electrode unit emits the second gas, and
in the subsequent melting, the second electrode unit emits a third gas that is different from the second gas.

6. The method of claim 5, wherein the second gas includes an inert gas, and the third gas includes a reducing gas.

7. The method of claim 6, wherein, in the initial melting, the second electrode unit is exposed to the outside, and
in the subsequent melting, the second electrode unit is at least partially submerged inside slag.

8. The method of claim 1, wherein the melting of the first iron source is performed simultaneously with the preheating of the second iron source and the melting of the second iron source.

9. The method of claim 8, wherein, in the melting of the first iron source, the first electrode unit emits a third gas.

10. The method of claim 9, wherein the third gas includes a reducing gas.

11. The method of claim 1, further comprising mixing a first slag inside the first melting furnace and a second slag inside the second melting furnace and refining a molten metal,
wherein, in the refining of the molten metal, the first electrode unit emits a third gas, and the second electrode unit emits a fourth gas,
wherein the third gas and the fourth gas include a reducing gas.

12. The method of claim 1, wherein the first electrode unit includes a first alternating current (AC) electrode rod, a second AC electrode rod, and a third AC electrode rod, and
the second electrode unit includes an upper direct current (DC) electrode and a lower DC electrode.

13. The method of claim 12, wherein the upper DC electrode includes:
an inner pipe which is defined to penetrate the upper DC electrode in a longitudinal direction and in which at least one of the first gas and the second gas flows;
a gas supply unit which is positioned at one side of the inner pipe and to which the at least one of the first gas and the second gas is supplied; and
a gas emission portion which is positioned at the other side of the inner pipe and from which the at least one of the first gas and the second gas is emitted.

14. The method of claim 12, wherein the first iron source includes an ore-based iron source, and
the second iron source includes scrap.

15. A method of operating an electric furnace, the method comprising:
inputting an iron source into an electric furnace including an electrode unit;
applying power to the electrode unit to melt the iron source; and
blowing oxygen into the electric furnace to perform refining,
wherein, in the melting of the iron source, the electrode unit emits a first gas, and in the refining, the electrode unit emits a second gas that is different from the first gas.

16. The method of claim 15, wherein the first gas includes an inert gas, and
the second gas includes a reducing gas.

17. The method of claim 15, wherein the electrode unit includes a first alternating current (AC) electrode rod, a second AC electrode rod, and a third AC electrode rod.

18. The method of claim 17, wherein each of the first AC electrode rod, the second AC electrode rod, and the third AC electrode rod emits at least one of the first gas and the second gas from within each of the first AC electrode rod, the second AC electrode rod, and the third AC electrode rod.

19. A method of operating an electric furnace which includes an electrode rod and in which a space for accommodating at least one of an iron source, pig iron, and slag is defined therein, the method comprising:
emitting, by the electrode rod, a first gas including an inert gas; and
emitting, by the electrode rod, a second gas including a reducing gas,
wherein, in the emitting of the first gas, one end portion of the electrode rod is exposed, and
in the emitting of the second gas, one end portion of the electrode rod is positioned inside the slag.

20. The method of claim 19, wherein the electrode rod includes:
an inner pipe in which the first gas and the second gas flow; and
a gas emission portion positioned at one side of the inner pipe and configured to emit the first gas and the second gas,
wherein the gas emission portion is disposed at the one end portion of the electrode rod.
